(19) United States
(12) Patent Application Publication
(10) Pub. No.: US 2007/0236639 A1
(43) Pub. Date: Oct. 11, 2007

(54) Liquid crystal panel having thin capacitor and method for fabricating same

(75) Inventor: Guo-Hua Yu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/784,851

(22) Filed: Apr. 9, 2007

(30) Foreign Application Priority Data
Apr. 7, 2006 (TW) 95112478

(51) Int. Cl. G02F 1/1343

(52) U.S. Cl. 349/139

(57) ABSTRACT

An exemplary liquid crystal panel (11) includes a first substrate (12), a second substrate (13) opposite to the first substrate, and a liquid crystal layer sandwiched between the first and second substrates. The second substrate includes a main portion and an extending portion (15). The extending portion has a capacitor (18) provided thereat. The capacitor includes an auxiliary conductive layer (180), two printed lines (182, 183) disposed in a same plane and being parallel to the auxiliary conductive layer, and an insulating layer (181) between the printed lines and the auxiliary conductive layer. The two printed lines both overlap with the auxiliary conductive layer. Unlike in conventional art, a total thickness of the auxiliary conductive layer, the insulating layer, and the printed lines is typically much less than a thickness of the first substrate. Thus, the liquid crystal panel has a smaller size.

### FIELD OF THE INVENTION

The present invention relates to liquid crystal panels typically used in liquid crystal displays (LCDs), and particularly to a liquid crystal panel having a thin capacitor at one of substrates thereof and a method for fabricating the liquid crystal panel.

### GENERAL BACKGROUND

A typical liquid crystal display (LCD) is capable of displaying a clear and sharp image through thousands or even millions of pixels that make up the complete image. The liquid crystal display has thus been applied to various electronic equipment in which messages or pictures need to be displayed, such as mobile phones and notebook computers. A liquid crystal display generally includes a liquid crystal panel for displaying images, and a backlight for illuminating the liquid crystal panel.

Referring to FIG. 6, a typical liquid crystal panel 1 is shown. The liquid crystal panel 1 includes a first substrate 2, a second substrate 3 opposite to the first substrate 2, and a liquid crystal layer (not visible) sandwiched between the first substrate 2 and the second substrate 3. The second substrate 3 includes an extending portion 5 at a side thereof. An integrated circuit 6, a plurality of wires 7, and two capacitors 8 are disposed on the extending portion 5. The integrated circuit 6 is used to drive the liquid crystal panel 1 via certain of the wires 7. The capacitors 8 are chip capacitors, and are connected to the integrated circuit 6 via certain of the wires 7 in order to provide boosting, filtering or voltage-regulating.

Being chip capacitors, the capacitors 8 generally have thicknesses greater than 0.5 millimeters. The capacitors 8 may even be thicker than the first substrate 2. The capacitors 8 add to an overall size of the liquid crystal panel 1.

Therefore, a new liquid crystal panel that can overcome the above-described problems is desired. What is also needed is a method for fabricating the above liquid crystal panel.

### SUMMARY

In one preferred embodiment, a liquid crystal panel includes a first substrate, a second substrate opposite to the first substrate, and a liquid crystal layer sandwiched between the first and second substrates. The second substrate includes a main portion and an extending portion. The extending portion has a capacitor provided thereat. The capacitor includes an auxiliary conductive layer, two printed lines disposed in a same plane and being parallel to the auxiliary conductive layer, and an insulating layer between the printed lines and the auxiliary conductive layer. The two printed lines both overlap with the auxiliary conductive layer.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an isometric view of a liquid crystal panel according to a first embodiment of the present invention, the liquid crystal panel including a plurality of capacitors.

FIG. 2 is a top plan view of part of the liquid crystal panel of FIG. 1, showing the capacitors.

FIG. 3 is a cross-sectional view taken along line III-III of FIG. 2.

FIG. 4 is similar to FIG. 3, but showing a corresponding view in the case of part of a liquid crystal panel according to a second embodiment of the present invention.

FIG. 5 is similar to FIG. 2, but showing a corresponding view in the case of part of a liquid crystal panel according to a third embodiment of the present invention.

FIG. 6 is an isometric view of a conventional liquid crystal panel.

### DETAILED DESCRIPTION OF PREFERRED EMBODIMENTS

In this description, unless the context indicates otherwise, a reference to a “printed line” is a reference to a printed electrically conductive line.

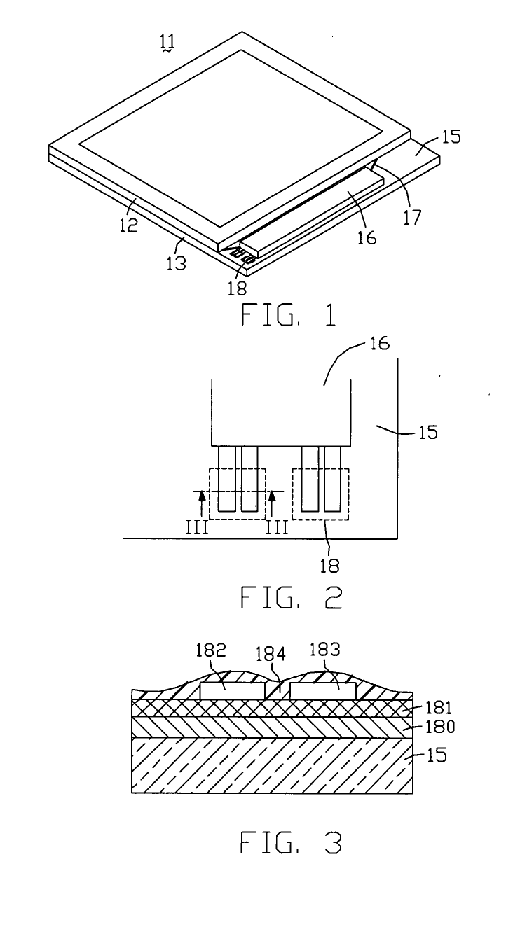

Referring to FIG. 1, a liquid crystal panel 11 according to a first embodiment of the present invention is shown. The liquid crystal panel 11 includes a first substrate 12, a second substrate 13 opposite to the first substrate 12, and a liquid crystal layer (not visible) sandwiched between the first substrate 12 and the second substrate 13. The second substrate 13 includes an extending portion 15 at a side thereof. An integrated circuit 16, a plurality of wires 17, and a plurality of capacitors 18 are disposed on the extending portion 15. The integrated circuit 16 is used to drive the liquid crystal panel 11 via certain of the wires 17. The capacitors 18 are connected to the integrated circuit 16 via certain of the wires 17, and are used to provide boosting, filtering or voltage-regulating.

Referring also to FIG. 2 and FIG. 3, each of the capacitors 18 includes an auxiliary conductive layer 180 arranged on the extending portion 15, an insulating layer 181 arranged on the auxiliary conductive layer 180, two printed lines 182, 183 arranged on the insulating layer 181, and a protective layer 184 arranged on the printed lines 182, 183 and the insulating layer 181. The printed lines 182, 183 are spaced apart from each other, and are parallel to each other. The printed lines 182, 183 both overlap the auxiliary conductive layer 180, thereby respectively defining a first capacitance C₁ and a second capacitance C₂. A capacitance C of the capacitor 18 can be calculated according to the following formula:

C=C₁C₂/(C₁+C₂).

The auxiliary conductive layer 180 and the printed lines 182, 183 can be made from transparent conductive material or metal. The transparent conductive material can for example be indium tin oxide (ITO) or indium zinc oxide (IZO). The metal can for example be any one or more items selected from the group consisting of aluminum, chromium, molybdenum, silver, and gold. The insulating layer 181 can for example be made from silica.

The auxiliary conductive layer 180, the insulating layer 181, the printed lines 182, 183, and the protective layer 183 of the capacitor 18 can be simultaneously formed when a thin film transistor (TFT) array of the liquid crystal panel 11 is formed. For example, the auxiliary conductive layer 180 can be formed when gate lines of the TFT array are formed. The insulating layer 181 can be formed when a gate insulating layer of the TFT array is formed. The printed lines 182, 183 can be formed when source and drain electrodes of the TFT array are formed. The protective layer 184 can be formed when a passivation layer of the TFT array is formed. In an alternative embodiment, the auxiliary conductive layer 180 can be formed when the source and drain electrodes of the TFT array are formed, the insulating layer 181 can be formed when the passivation layer of the TFT array is formed, and the printed lines 182, 183 can be formed when a pixel electrode of the TFT array is formed. In another alternative embodiment, the capacitors 180 can be formed after the TFT array is formed.

In any of the above-described embodiments, once the first substrate 12 and the second substrate 13 have been prepared and are ready for assembly, liquid crystal material is provided. The first and second substrates 12, 13 and the liquid crystal material can be assembled together by any of various known methods, such as a one-drop-fill method or a vacuum filling method. Thereby, the liquid crystal panel 11 having the first substrate 12, the second substrate 13, and the liquid crystal layer sandwiched between the first and second substrates 12, 13 is obtained.

Unlike in conventional art, a total thickness of the auxiliary conductive layer 180, the insulating layer 181, the printed lines 182, 183, and the protective layer 184 is typically much less than a thickness of the first substrate 12. Thus, the liquid crystal panel 11 has a smaller size.

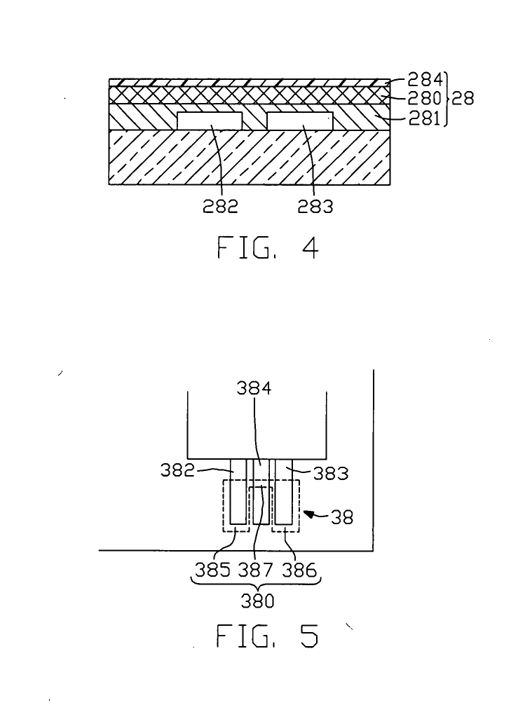

Referring to FIG. 4, a liquid crystal panel according to a second embodiment of the present invention is similar to the liquid crystal panel 11 of the first embodiment. However, each of one or more capacitors 28 includes two printed lines 282, 283 arranged on an extending portion (not labeled), an insulating layer 281 arranged on the printed lines 282, 283 and the extending portion, an auxiliary conductive layer 280 arranged on the insulating layer 281, and a protective layer 284 arranged on the auxiliary conductive layer 280.

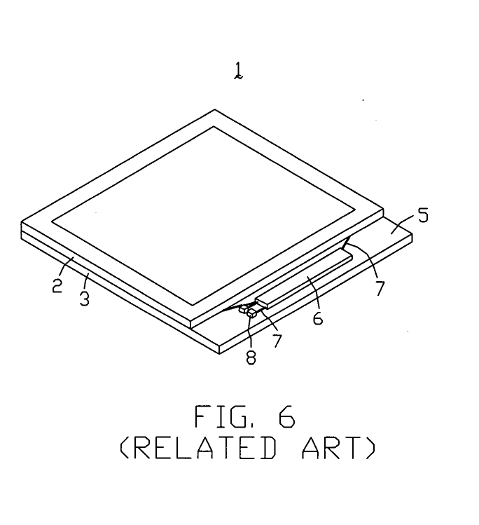

Referring to FIG. 5, a liquid crystal panel according to a third embodiment of the present invention is similar to the liquid crystal panel of the second embodiment. However, each of one or more capacitors 38 includes three printed lines 382, 383, 384 and an auxiliary conductive layer 380. The printed lines 382, 383, 384 are spaced apart from each other, and are parallel to each other. The printed line 384 is located between the printed lines 382, 383. The auxiliary conductive layer 380 includes a first electrode 385, a second electrode 386, and a connecting portion 387 interconnecting the first and second electrodes 385, 386. The first electrode 385 overlaps the printed line 382, thereby defining a first capacitance C₁. The second electrode 386 overlaps the printed line 383, thereby defining a second capacitance C₂.

Further or alternative embodiments may include the following. In one example, each capacitor can include only one printed line, or more than three printed lines.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel comprising:
a first substrate;
a second substrate opposite to the first substrate, the second substrate comprising a main portion and an extending portion, the extending portion having a capacitor provided thereat, the capacitor comprising an auxiliary conductive layer, two printed lines disposed in a same plane and being parallel to the auxiliary conductive layer, and an insulating layer between the printed lines and the auxiliary conductive layer; and
a liquid crystal layer sandwiched between the first substrate and the main portion of the second substrate.

2. The liquid crystal panel as claimed in claim 1, wherein the auxiliary conductive layer is arranged on the extending portion, the insulating layer is arranged on the auxiliary conductive layer, and the printed lines are arranged on the insulating layer.

3. The liquid crystal panel as claimed in claim 2, further comprising a protective layer arranged on the printed lines and the insulating layer.

4. The liquid crystal panel as claimed in claim 1, wherein the printed lines are arranged on the extending portion, the insulating layer is arranged on the printed lines and the extending portion, and the auxiliary conductive layer is arranged on the insulating layer.

5. The liquid crystal panel as claimed in claim 4, further comprising a protective layer arranged on the auxiliary conductive layer.

6. The liquid crystal panel as claimed in claim 4, wherein the auxiliary conductive layer comprises a first electrode overlapping one of the printed lines, a second electrode overlapping the other printed line, and a connecting portion interconnecting the first electrode and the second electrode.

7. The liquid crystal panel as claimed in claim 6, wherein the capacitor further comprising another printed line, which is overlapped by the connecting portion.

8. The liquid crystal panel as claimed in claim 1, wherein the auxiliary conductive layer is made from material including any one or more items selected from the group consisting of aluminum, chromium, molybdenum, silver, and gold.

9. The liquid crystal panel as claimed in claim 1, wherein the auxiliary conductive layer is made from indium tin oxide or indium zinc oxide.

10. The liquid crystal panel as claimed in claim 1, wherein the printed lines are made from material including any one or more items selected from the group consisting of aluminum, chromium, molybdenum, silver, and gold.

11. The liquid crystal panel as claimed in claim 1, wherein the printed lines are made from indium tin oxide or indium zinc oxide.

12. The liquid crystal panel as claimed in claim 1, wherein the insulating layer is made from silica.

13. The liquid crystal panel as claimed in claim 1, further comprising an integrated circuit and a plurality of wires all located at the extending portion, wherein the integrated circuit is configured to drive the liquid crystal panel.

14. The liquid crystal panel as claimed in claim 13, wherein the capacitor is connected to the integrated circuit via at least one of the wires.

15. The liquid crystal panel as claimed in claim 3, further comprising the following elements formed at the main portion of the second substrate: a plurality of gate lines, a gate insulating layer arranged on the gate lines, source and drain electrodes arranged on the gate insulating layer, a passivation layer arranged on the source and drain electrodes and the gate insulating layer, and a pixel electrode arranged on the passivation layer.

16. The liquid crystal panel as claimed in claim 15, wherein the auxiliary conductive layer is formed of the same material as that of the gate lines, the insulating layer is formed of the same material as that of the gate insulating layer, the printed lines are formed of the same material as that of the source and drain electrodes, and the protective layer is formed of the same material as that of the passivation layer.

17. The liquid crystal panel as claimed in claim 15, wherein the auxiliary conductive layer is formed of the same material as that of the source and drain electrodes, the insulating layer is formed of the same material as that of the passivation layer, and the printed lines are formed of the same material as that of the pixel electrode.

18. A method for fabricating a liquid crystal panel, the method comprising:
providing a first substrate;
providing a second substrate, the second substrate comprising a main portion and an extending portion;
forming gate lines on the main portion and an auxiliary conductive layer on the extending portion;
forming an insulating layer on the gate lines and on the auxiliary conductive layer;
forming source and drain electrodes on the insulating layer of the main portion and two printed lines on the insulating layer of the extending portion;
forming a passivation layer on the source and drain electrodes, the printed lines, and the insulating layer; and
providing liquid crystal material, and assembling the first substrate, the second substrate and the liquid crystal material to form the liquid crystal panel.

19. A method for fabricating a liquid crystal panel, the method comprising:
providing a first substrate;
providing a second substrate, the second substrate comprising a main portion and an extending portion;
forming gate lines on the main portion;
forming an insulating layer on the gate lines and on the main portion;
forming source and drain electrodes on the insulating layer and an auxiliary conductive layer on the extending portion;
forming a passivation layer on the source and drain electrodes, the auxiliary conductive layer, and the insulating layer;
forming a pixel electrode on the passivation layer of the main portion and two printed lines on the passivation of the extending portion; and
providing liquid crystal material, and assembling the first substrate, the second substrate and the liquid crystal material to form the liquid crystal panel.
